(19) United States
(12) Patent Application Publication
(10) Pub. No.: US 2009/0223540 A1
(43) Pub. Date: Sep. 10, 2009

(54) Steam Mop Pad With Pocket

(76) Inventors: Maximilian Rosenzweig, Montreal (CA); Ognjen Vrdoljak, Laval (CA)

Correspondence Address: Michael I. Wolfson;Greenberg Traurig, LLP, 200 Park Avenue, New York, NY, 10166, US

(21) Appl. No.: 12/044,402

(22) Filed: Mar. 7, 2008

(51) Int. Cl. B08B 3/00

(52) U.S. Cl. 134/105

(57) ABSTRACT

A fabric steam pad for use with a steam mop of at least one layer of fabric with an border overlapping a portion of the inner surface of the steam pad to form an interior cavity pocket with a drawstring or an elastic band around the perimeter of the fabric border layer to engage a steam frame. The pad is adapted to fit around the bottom of the steam pad frame to distribute cleaning steam to the surface to be cleaned. In another embodiment, a fabric steam pad for use with a steam mop having a steam pad frame with an outer steam surface and an upper surface. The steam pad comprising at least one layer of fabric having an outer cleaning surface, an opposed inner surface, a fabric border about the perimeter so that the border overlaps the inner surface to form a cavity, and a pair of straps that extend across the inner cavity of steam pad.

### BACKGROUND OF THE INVENTION

The invention relates generally to a steam mop pad, and more particularly to a fabric steam pad with pocket for use with a steam mop.

Conventional mops have been widely used for cleaning floors. However, conventional mops have not been effective at cleaning dirt in small crevices and floor gaps. In addition, conventional mops require frequent rising since mops can only effectively clean a small surface area at a time.

Steaming devices used to apply steam to household objects are well known. The uses of the devices vary widely, and may include the application of steam to drapes or other fabrics to ease wrinkles, and the application of steam to objects to assist in cleaning the objects.

Typical steam devices have a reservoir for storing water that is connected to an electrical water pump with an on/off switch. The exit from the electric water pump is connected to a steam boiler with a heating element to heat the water. The heated water generates steam, which may be directed towards its intended destination through a nozzle which controls the application of the steam. Variation of the shape and size of the nozzle allows for preferred distribution of generated steam to an object to be cleaned. The nozzles may be disconnectable from the steam generator to allow different nozzles to be utilized, based on the object to be steamed. The nozzle may be either closely coupled to the steam generator, or located at a distance from the steam generator, requiring tubing or other steam transfer structures to be interconnected between the steam generator and the discharge nozzle. Typically, it is beneficial to provide suitable connectors between the steam generator and the nozzle to allow either the nozzle to be connected to the steam generator, or to allow the interpositioning of transfer tubes or hoses between the steam generator and the nozzle.

In general, the nozzles used with the steam cleaners do not have large surface areas and a cloth to absorb the liquid condensate of the steam. In one embodiment, the fabric pad is secured to the nozzle by an elastic band, a drawstring clamp or a pair of straps. In another embodiment, the fabric pad with the elastic band or the fabric pad with the drawstring clamp may be further secured to the steam mop frame by a pair of straps. Optionally, the fabric pad may be reversible for dual side cleaning. Often steam injected behind the cloth passes through the cloth at the points the bristles contact on the cloth. This tends to wet the cloth and reduce the cleaning effectiveness of the steam.

Notwithstanding the wide variety of steam generating appliances available, there exists the need to provide steam mop pads that are easy to use with steam mops and effectively improve the effective steaming surface area of the steam cleaners. It is desirable to provide the ability for a user to change the mop pad easily.

### SUMMARY OF THE INVENTION

Generally speaking, in accordance with the invention, a fabric steam pad and pocket for mounting on a steam pad frame is provided. The steam pad has a cleaning surface with a fabric border that overlaps the back of the cleaning surface to form an interior cavity or pocket with an elastic band or a drawstring around the outer perimeter of the border that stretches to fit around the bottom of the steam pad frame to secure the steam pad to the frame.

In one embodiment, the fabric steam pad includes a pair of straps that bind the outer elastic perimeter border with straps or bands across the top of steam pad frame. The pair of straps have fasteners one side for securing the steam pad in place over the steam frame for secure installation.

Accordingly, it is an object of the invention to provide a fabric steam pad with a pocket that is easily mounted on and removed from a steam pad frame.

Yet a further object of the invention is to provide a steam pad frame attachment with a fabric pad that does not allow steam to escape at points of contact with brush bristles.

Another object of the invention is to provide a steam mop and steam pocket frame attachment to provide increased steam cleaning surface area.

Still other objects and advantages of the invention will in part be obvious and will in part be apparent from the specification.

The invention accordingly comprises a product possessing the features, properties, and the relation of components which will be exemplified in the product hereinafter described, and the scope of the invention will be indicated in the claims.

### BRIEF DESCRIPTION OF THE DRAWINGS

For a fuller understanding of the invention, reference is made to the following description taken in connection with the accompanying drawing(s), in which:

FIG. 1 is a perspective view of a fabric steam pad with a pocket constructed and arranged in accordance with the invention mounted on a steam mop;

FIG. 2 is a perspective view of the fabric steam pad of FIG. 1 with additional fastening straps for securing attachment of the steam pad in accordance with the invention;

FIG. 3 is a plan view of the outer cleaning surface of the steam pad of FIGS. 1 and 2;

FIG. 4 is a plan view of the upper surface of the steam pad of FIG. 1;

FIG. 5 is a plan view of the upper surface of the steam pad of FIG. 4 with additional fastening straps;

FIG. 6 is a bottom plan view of a steam pad frame of the steam mop of FIGS. 1 and 2;

FIG. 7 is a front plan view of the mop housing showing a water reservoir, pump and boiler of the steam mop of FIGS. 1 and 2; and

FIG. 8 is a section view of the elements of FIG. 7.

### DETAILED DESCRIPTION OF THE INVENTION

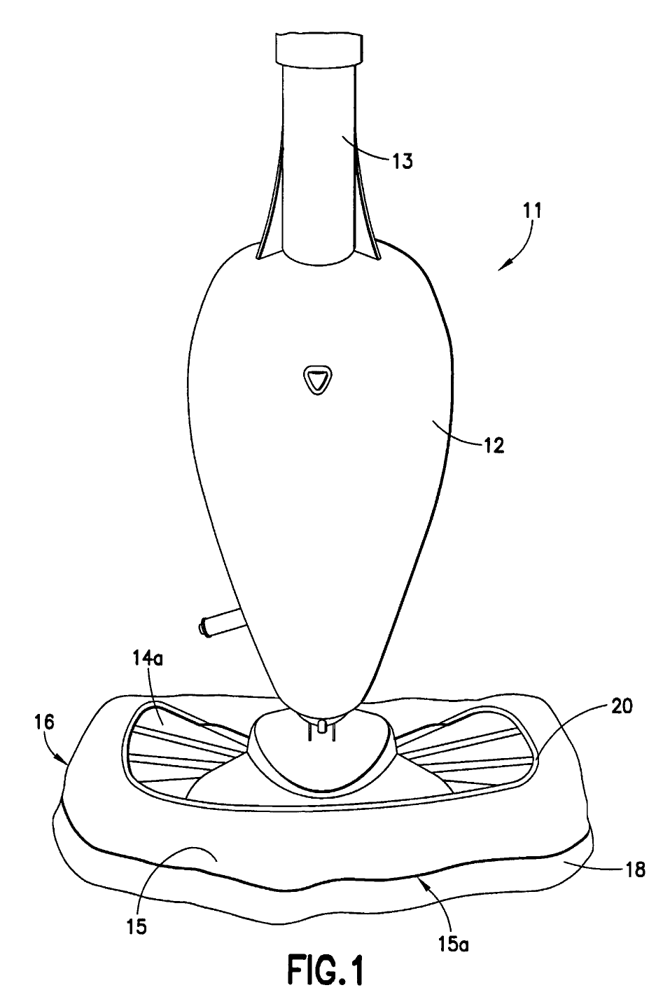

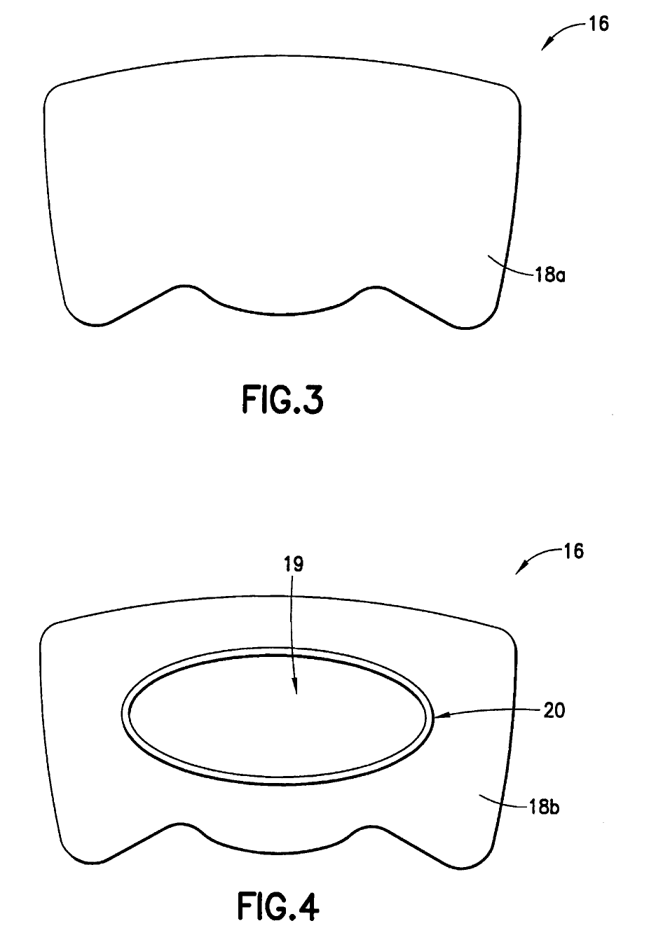

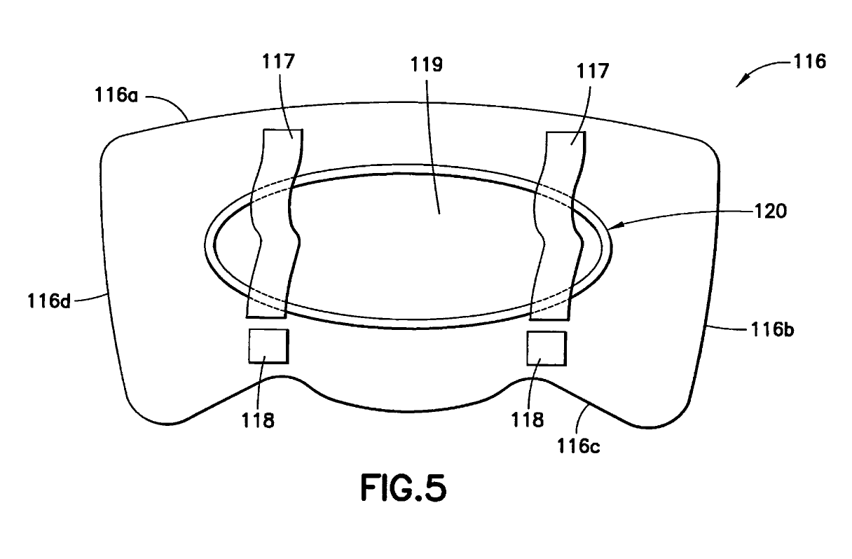

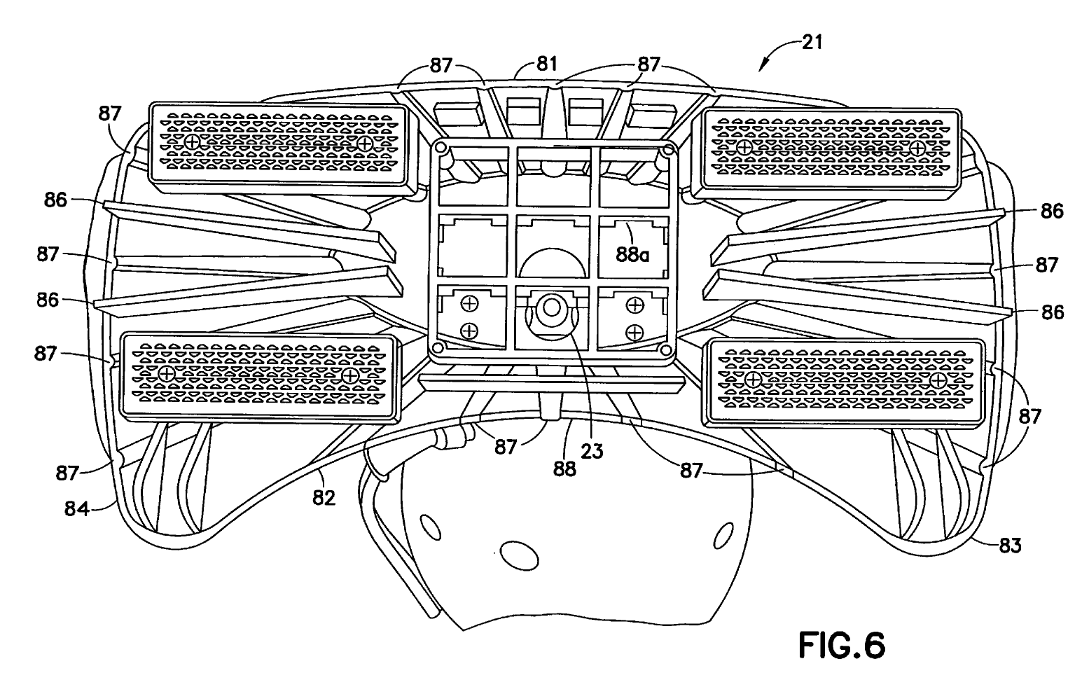

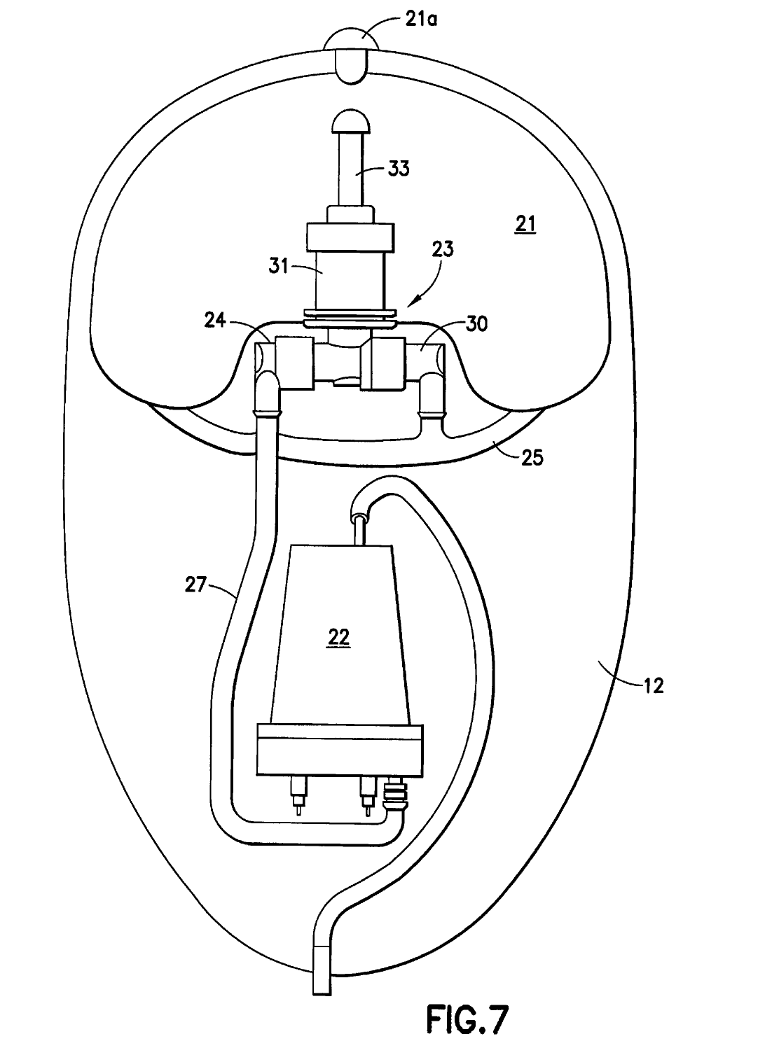

FIG. 1 is a perspective view of a steam mop 11 with a fabric steam pad 16 mounted thereon constructed and arranged in accordance with the invention. Mop 11 includes a housing or main body 12 connected to a steam pad frame 14 at one end and having a handle 13 at the opposite end. Steam frame 14 has an upper surface 14a and an opposed bottom cleaning surface 14b as shown in FIG. 6. Fabric steam pad 16 has a fabric cleaning section 18 with a bottom cleaning surface 18a as shown in FIG. 3 and an upper surface 18b. Border 15 is stitched to the perimeter of bottom section 18 by a seam 15a. Fabric cleaning section 18 of steam pad 16 includes a border 15 having an elastic band 20 stitched around the perimeter of the border to create an inner cavity or pocket 19 as shown in FIG. 4 that is adapted to fit around the bottom of steam pad frame 14. In another embodiment, fabric steam pad 16 includes a border 15 having a drawstring with an optional drawstring clamp (not shown) around the perimeter of border 15 instead of elastic band 20.

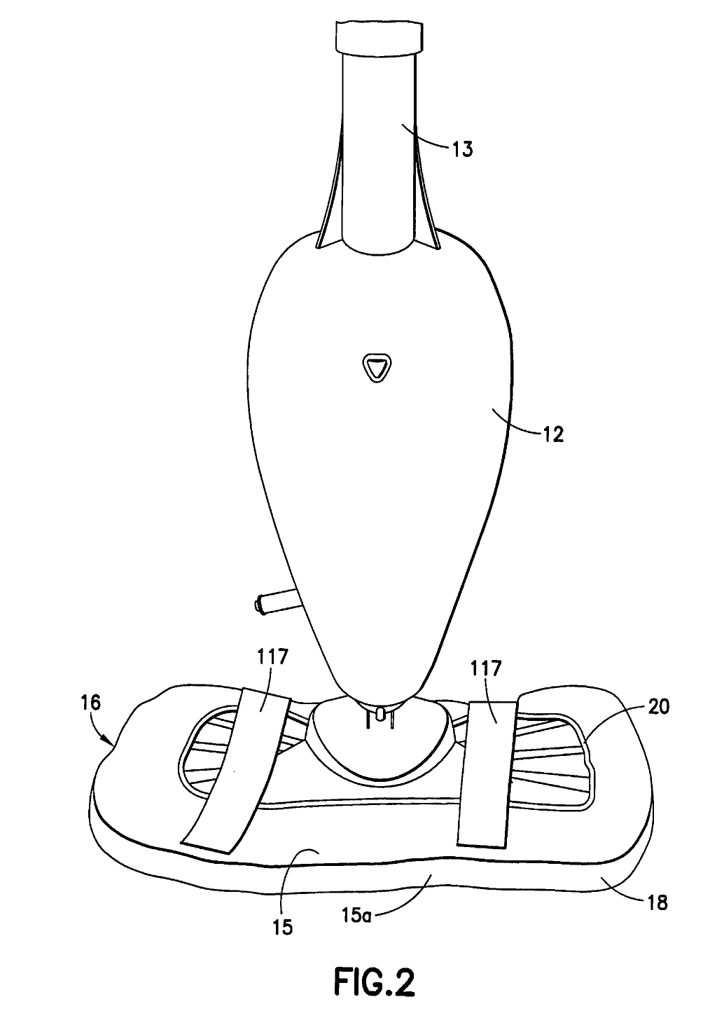

FIG. 2 shows another embodiment with fastening straps 117 that fit across the upper surface 14a of frame 14. Straps 117 may be secured to pad 16 near elastic band 20. Alternatively, strap 117 may be secured at one end and have a hook-and-loop fastening elements 118 on the opposite end of strap 117.

FIG. 4 is a top plan view of fabric steam pad 16 of FIG. 1 suitable for use with the steam pad frame 14. Elastic band 20 is stitched into inner periphery of border 15. Elastic band 20 easily slips over steam pad frame 14 to secure steam pad 16 to frame 14 and provides for easy installation and removal.

In the illustrated embodiment, steam pad 16 is a cloth or towel. It may be formed of any suitable fabric such as cotton or a synthetic fabric, such as polyester or polyolefin fiber. Preferably, the fabric of pad 16 is a microfiber. Most preferably, the microfiber is a synthetic polyester microfiber.

FIG. 5 is a top plan view of a fabric steam pad 116 suitable for use with the steam pad frame 14 in accordance with another embodiment of the invention. Steam fabric pad 116 is configured to attach to frame 14 as pad 16 in FIG. 1 and has an inner cavity 119 with an elastic band 120 about the inner periphery of a border 115. Elastic band 120 easily slips over steam pad frame 14 for easy installation and removal. Here, fabric steam pad 116 has a rectangular shape with two oppose long borders 116a and 116c and two opposed short sides 116b and 116d. Fabric steam pad 116 has a pair of fastening straps 117 that are fixed to long border 116a of steam pad 116 to attached to respective fasteners 118 on long border 116c, such as hook-and-loop fastening elements. Alternatively, straps 117 may be secured at both ends. In another embodiment, fabric steam pad 116 with pair of fastening straps 117 does not necessarily have an elastic band or a drawstring.

In the preferred embodiment, fastening straps 117 are secured to long border 116a and have attached to hook-and-loop type fasteners 118 to attack removably to second long border 116c. Alternatively, straps 117 may include buttons, snaps or other types of fasteners may be used to secure and hold steam pad 116 in place when used to clean a floor or other surface. In each case, fastening straps 117 are across frame 14 and secured to hold pad 116 in place when used to clean a floor or other surface.

Steam pocket 116 is a cloth or towel. It may be formed of any suitable fabric such as cotton or a synthetic fabric, such as polyester or polyolefin fiber. Preferably, the fabric of pocket 116 is a microfiber. Most preferably, the microfiber is a synthetic polyester microfiber.

FIG. 6 is a bottom perspective view of a rectangular steam pocket frame 14 including a front wall 81, a rear wall 82, a right side wall 83 and a left side wall 84. Steam pocket frame 14 includes a plurality of vanes 86 and a plurality of grooves 87 to help disperse the steam uniformly throughout frame 14 when steam pocket 16 or 116 is attached to steam pocket frame 14 as shown in FIGS. 1 and 2, respectively.

A plurality of baffles 88 in a square grid formation extending outwardly from a steam outlet opening 26 toward the four sides of the steam pad frame 14 to the cleaning surface within frame 14. Baffles 88 are planar in shape have a plurality of vents or openings 88a between the grids for distributing steam into the spaces between baffles 88 and to a steam pad mounted thereon.

Referring now to FIG. 7, mop housing 12 shown in FIG. 7 includes a water container or tank 21 as part of the upper part of housing 12 and is connected to a boiler 22 by a pump 23 having a one-way outlet valve 24. Any type of mechanical pump or some other means of transporting the water to the boiler may be used with steam mop 11. Preferably, pump 23 is a mechanical pump, such as a bellows pump or a piston pump, that is actuated by movement of mop 11 by a user pushing and pulling handle 13.

Steam generated in steam boiler 22 shown in FIG. 7 dispenses steam into frame 14 to steam outlet opening 26 of frame 14. A fabric steam pad 16 is mounted on frame 14 by an elastic band 20 around the periphery of the end of fabric steam pad 16.

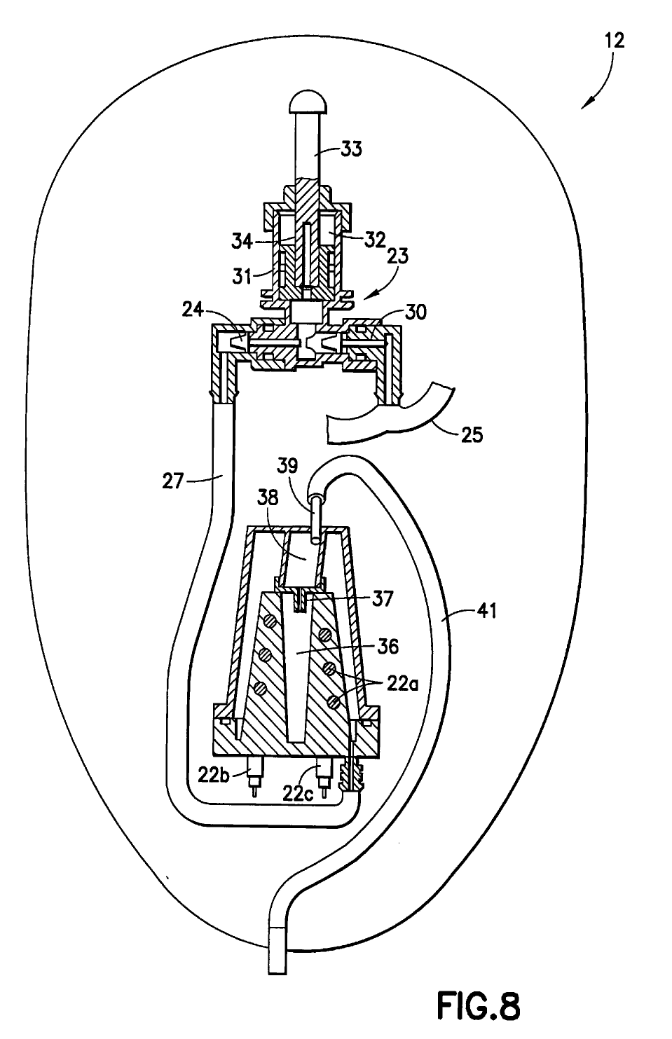

FIGS. 7 and 8 are a front plan and section views, respectively, of the elements in housing 12 of steam mop 11. This includes water container or tank 21, one-way pump 23 and boiler 22. A pump water supply hose 25 is connected to a one-way inlet valve 30. A pump water outlet 24 is connected to boiler 22 through a boiler water supply hose 27. Water container 21 includes an opening 21a that may be easily opened and closed for the user to fill mop 11 with water.

Water pump 23 includes a pump body 31 having a pump cavity 32. A piston 33 connected to a push rod 34 is positioned in cavity 32. As mop handle 13 is pulled by a user, push rod 34 and piston 33 create a negative pressure in cavity 32. This draws water from tank 21 into pump water supply hose 25 and into one-way inlet valve 30. As handle 13 is pushed during use, water in cavity 32 is expelled through one-way outlet valve 24. This pumped water then passes to boiler 22. Water in boiler 22 is heated by a heating element 22a in a boiler cavity 36 and steam generated is fed through a steam valve 37 into a steam chamber 38. Heating element 22a is connected to electrical connectors 22b and 22c. Steam is then expelled through a steam outlet 39 to a steam hose 41 and to frame nozzle 16.

One-way inlet valve 30 and one-way outlet valve 24 are formed of a flexible elastomeric material, such a rubber. The valves are conical in shape so that when handle 13 is pulled, water is drawn through inlet valve 30 while outlet valve 24 remains closed. Similarly, when handle 13 is pushed, water is forced out through outlet valve 24 and inlet valve 30 remains closed and water is fed into boiler 22.

Steam floor mop 11 provides many advantages for ease of use because it eliminates the need for an electric water pump and an on/off switch to activate the electric water pump. Here, the user has more control over the amount of water needed to be discharged into the boiler and consequently, how much steam is needed by moving the mop forward and backwards. In addition, steam mop is designed as a low pressure or non-pressurized system so it is safer for the user to use. Further, since the amount of water routed to the boiler is controlled, the boiler can create steam in a short amount of time.

Steam mop 11 with fabric steam pad frame 14 and fabric steam pockets 16 and 116 in accordance with the invention provide vast improvements over placing a towel onto a bristle attachment for a steam cleaner, respectively. The invention avoids puncture of the cloth by the bristles and provides twice the cleaning surface. Moreover, the fabric cover is easily installed securely and replaced.

It will thus be seen that the objects set forth above, among those made apparent from the preceding description, are efficiently attained and, since certain changes may be made in the above product without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

The present invention may be embodied in other specific forms without departing from the spirit or essential attributes of the invention. Accordingly, reference should be made to the appended claims, rather than the foregoing specification, as indicating the scope of the invention. A steam mop having a pump that pumps water from a water container to a steam generator in response to movement of the mop handle with the steam fed to a fabric pocket cover in accordance with the invention provides a vast improvement over electrical pumps. The pump may include a two-way valve that pumps water in response to both the push and pull of the mop.

What is claimed is:

1. A fabric steam pad for use with a steam mop having a steam pad frame with an outer steam surface and an upper surface, the steam pad comprising at least one layer of fabric having an outer cleaning surface and an opposed inner surface and a fabric border about the perimeter with a drawstring on the perimeter of the border so that the border overlaps the inner surface to form the cavity.

2. The fabric steam pad of claim 1, wherein the layer of fabric is formed of a microfiber.

3. The fabric steam pad of claim 2, wherein the microfiber is a polyester.

4. The fabric steam pad of claim 1, wherein the layer of fabric is cotton.

5. The fabric steam pad of claim 1, further comprising a pair of straps that extend across the inner cavity of steam pad.

6. The fabric steam pad of claim 1, wherein the drawstring has a clamp to hold the drawstring in place.

7. A steam pad frame and fabric steam pocket, comprising a steam pad frame with a substantially planar outer steam surface and an opposed outer surface, and the steam pocket of at least one layer of fabric having a surface area corresponding to the steam pad frame and having an outer cleaning surface and a fabric border about the perimeter thereof to form an interior cavity with a drawstring on the perimeter of the border so that the border overlaps the inner surface of the steam pad frame and the pocket engages the steam pad frame.

8. A fabric steam pad for use with a steam mop having a steam pad frame with an outer steam surface and an upper surface, the steam pad comprising at least one layer of fabric having an outer cleaning surface and an opposed inner surface and a fabric border about the perimeter with an elastic band on the perimeter of the border so that the border overlaps the inner surface to form the cavity.

9. The fabric steam pad of claim 8, wherein the layer of fabric is formed of a microfiber.

10. The fabric steam pad of claim 9, wherein the microfiber is a polyester.

11. The fabric steam pad of claim 8, wherein the layer of fabric is cotton.

12. The fabric steam pad of claim 8, further comprising a pair of straps that extend across the inner cavity of steam pad.

13. A steam pad frame and fabric steam pocket, comprising a steam pad frame with a substantially planar outer steam surface and an opposed outer surface, and the steam pocket of at least one layer of fabric having a surface area corresponding to the steam pad frame and having an outer cleaning surface and a fabric border about the perimeter thereof to form an interior cavity with an elastic band on the perimeter of the border so that the border overlaps the inner surface of the steam pad frame and the pocket engages the steam pad frame.

14. A fabric steam pad for use with a steam mop having a steam pad frame with an outer steam surface and an upper surface, the steam pad comprising at least one layer of fabric having an outer cleaning surface; an opposed inner surface; a fabric border about the perimeter so that the border overlaps the inner surface to form a cavity; and a pair of straps extend across the inner cavity of steam pad.

15. The fabric steam pad of claim 14, wherein the layer of fabric is formed of a microfiber.

16. The fabric steam pad of claim 15, wherein the microfiber is a polyester.

17. The fabric steam pad of claim 14, wherein the layer of fabric is cotton.

18. A steam pad frame and fabric steam pocket, comprising a steam pad frame with a substantially planar outer steam surface and an opposed outer surface, and the steam pocket of at least one layer of fabric having a surface area corresponding to the steam pad frame and having an outer cleaning surface and a fabric border about the perimeter thereof to form an interior cavity on the perimeter of the border so that the border overlaps the inner surface of the steam pad frame and the pocket engages the steam pad frame, wherein a pair of straps extend across the inner cavity of steam pad.
